(19) United States
(12) Patent Application Publication
(10) Pub. No.: US 2025/0320016 A1
(43) Pub. Date: Oct. 16, 2025

(54) LABELING DEVICE FOR LABELING FLEXIBLE PACKS FILLED WITH A PRODUCT

(71) Applicant: MULTIVAC MARKING & INSPECTION GMBH & CO. KG, Enger (DE)

(72) Inventors: Tobias SCHRÖDER, Enger (DE); Udo HENRICHS, Bielefeld (DE); Markus DAUWE, Hilter (DE)

(73) Assignee: MULTIVAC MARKING & INSPECTION GMBH & CO. KG, Enger (DE)

(21) Appl. No.: 18/749,091

(22) Filed: Jun. 20, 2024

(30) Foreign Application Priority Data
Apr. 16, 2024 (DE) 102024110562.3

(51) Int. Cl. B65C 9/36; B65C 3/26

(52) U.S. Cl. CPC B65C 9/36; B65C 3/26

(57) ABSTRACT

A labeling device for labeling packs filled with a product includes a transport device for transporting packs along a direction of transport and a labeling unit for applying labels to packs. The transport device comprises a depression for receiving a pack and boundary surfaces on at least two sides of the depression, wherein the depression and the boundary surfaces are arranged such that the pack with the product can be arranged in the depression and a pack component on at least one of the boundary surfaces. The labeling unit is configured to apply a label to the pack while the product is arranged in the depression.

### CROSS REFERENCE TO RELATED APPLICATIONS

This application claims foreign priority benefits under 35 U.S.C. § 119 (a)-(d) to German patent application number DE 102024110562.3 filed, Apr. 16, 2024, which is incorporated by reference in its entirety.

### TECHNICAL FIELD

The present disclosure relates to a labeling device for labeling packs filled with a product and a method for labeling packs filled with a product using a labeling device.

### BACKGROUND

Labeling devices and methods for labeling products and in particular packs are well known from the prior art. The labels are typically applied to a flat or only slightly curved surface of the pack in order to achieve the labeling result to be as wrinkle-free as possible.

However, there are packs, in particular deep-drawn packs with elongate products and therefore usually also an elongated shape of the packs which can only be labeled with great effort. If the packs are arranged, for example, lengthwise along the direction of transport, a good labeling result is still possible since the surface to be labeled is substantially flat, but at the same time this results in a large spacing between successive packs to be labeled so that, in particular when small labels are applied, only a reduced throughput can be achieved for elongate products in this arrangement since the transport speed of the products can also not be increased arbitrarily due to limitations in the labeling process. Furthermore, the alignment of the products along the direction of transport, in particular in the case of elongate labels to be applied, can require that the labels likewise be present in the longitudinal direction, for example, on a label roll. This reduces the number of labels available per roll for a given label roll size.

Other arrangements of the packs with products, however, cause a relative arrangement of the surface to be labeled relative to the labeling unit, in which a flat or substantially flat surface to be labeled cannot be provided.

### SUMMARY

Starting out from known prior art, a technical object to be satisfied is to provide a device for labeling packs filled with a product with which a high throughput and at the same time high labeling quality can be achieved even with elongate packs.

This object is satisfied by the labeling machine for labeling packs filled with a product according to the disclosure and by a method for labeling packs filled with a product using a labeling device according to the disclosure. Advantageous further developments of according to the disclosure are also provided.

The labeling device according to the disclosure for labeling packs filled with a product comprises a transport device for transporting packs along a direction of transport and a labeling unit for applying labels onto the packs, the transport device comprising a depression for receiving the pack and boundary surfaces on at least two sides of the depression, where the depression and the boundary surfaces are arranged such that the pack with the product can be arranged in the depression and a pack component on at least one of the boundary surfaces, and where the labeling unit is configured to apply a label onto the pack while the product is arranged in the depression.

The packs filled with a product can be, for example, deep-drawn packs or flexible packs (such as film bags) into which a product has been filled and which have preferably already been closed. The packs can be dimensionally stable or not dimensionally stable and the disclosure is not restricted in this regard. Preferably, but not necessarily, the packs are elongated packs which have a greater extension in one direction than in a direction extending perpendicular thereto, where both directions in the transport plane of the packs can run in the transport device. The packs are preferably arranged in the depressions and the boundary surfaces such that their longest extension is arranged to be transverse to the direction of transport.

A pack component is hereinafter understood to mean, for example, a part of the seal or the sealing seam or another part of the pack that does not contain the product. In particular, this can be understood to mean adhesive edges or adhesive corners or edges of the pack.

By arranging the part of the pack in which the product is arranged in the depression and at least one pack component resting on the boundary surface, any height difference that arises from the spatial extension of the product in the pack is compensated for and the labeling unit can be used to reliably apply the label, where it is no longer necessary to arrange the pack lengthways in the direction of transport. This allows the throughput to be increased, in particular for elongate packs, while still ensuring the quality of the labeling result. As an alternative to increased throughput, the transport speed of the packs and therefore the speed at which the labels need to be applied to the packs can be reduced while maintaining the same throughput. This can likewise have a positive effect on the labeling result. Depending on the configuration of the labels (in particular with elongate labels), there can also be the possibility as an alternative or in addition to the improved throughput of accommodating more labels on a label roll having the same circumference or diameter so that the frequency of roll changes in the labeling unit can be reduced.

It can be provided that the boundary surfaces are arranged to be transverse to the direction of transport. This also prevents the pack from slipping in the direction of transport during the labeling process and, in addition, this embodiment can be used to label elongate packs in particular.

In one embodiment, the labeling unit is configured to apply a label to the pack in a labeling direction parallel to the direction of transport. If the direction of transport and the labeling device run transverse to the longitudinal axis of the pack, then this embodiment can achieve a high throughput with good labeling results at the same time.

The transport device can comprise a plurality of depressions and boundary surfaces and adjacent depressions can optionally be separated from one another by a boundary surface. All boundary surfaces are preferably configured to be identical. It is possible with this embodiment to label with high quality and at high throughput a plurality of individual packs as well as packs connected to form chains.

It can be provided that the labeling device comprises a pressing device upstream of an application point for labels and the pressing device be configured to press the pack with the product into the depression. The pressing device can comprise a movable punch and/or a pressure roller and/or a pressure plate. The pressing device can thus compensate for or reduce any existing height differences in the pack by pressing onto the pack and thus pushing the product into the depression, which allows for subsequent labeling with improved reliability.

In is provided in one embodiment that the transport device comprises a conveyor belt and where the boundary surfaces are arranged on the conveyor belt, and the depressions are defined at least in part by the boundary surfaces and the conveyor belt.

In this sense, the depression is open at the top (viewed from the transport plane of the packs in the transport device) and defined at the bottom by the conveyor belt and on at least two sides by the boundary surfaces. This configuration can be flexibly adapted to different packs as well as transport speeds.

The boundary surfaces can be connected in a detachable manner to the conveyor belt. The detachable connection of the boundary surfaces to the conveyor belt can be achieved, for example, by way of click or plug connections, where a detachable connection between the boundary surfaces and the conveyor belt is to be understood to be a connection that can be detached in a manner that is non-destructive at least for the boundary surfaces and the conveyor belt. This makes it possible to easily convert the labeling device, for example, when changing the format of the packs.

It can be provided that an extension of the depression in a direction transverse to the direction of transport is greater than an extension of the depression parallel to the direction of transport. With this embodiment, elongate packs can be arranged at the shortest possible distance from one another so that a high throughput during labeling can be ensured despite the comparatively low transport speed of the packs.

According to the disclosure, a method for labeling packs filled with a product using a labeling device is furthermore provided, the labeling device comprising a transport device for transporting packs along a direction of transport and a labeling unit for applying labels to packs, the transport device comprising a depression for receiving the pack and boundary surfaces on at least two sides of the depression, where the depression and the boundary surfaces are arranged such that the pack with the product can be arranged in the depression and a pack component on at least one of the boundary surfaces, and the method comprising applying a label onto the pack while the product is arranged in the depression.

With this method, packs can be reliably labeled regardless of their extension along or transverse to the direction of transport.

The boundary surfaces can be arranged to be transverse to the direction of transport. This prevents the packs from slipping.

In one embodiment, it is provided that the labeling unit applies the label onto the packs in a labeling direction parallel to the direction of transport. This reduces the shearing forces acting upon the label during the application, thereby preventing damage.

It can be provided that the transport device comprises a plurality of depressions and boundary surfaces and that adjacent depressions are optionally separated from one another by a boundary surface. With this embodiment, individual packs as well as chain packs, which comprises interconnected individual packs, can be labeled reliably.

It can be provided in one embodiment that the labeling device comprises a pressing device upstream of an application point of labels and where the pressing device presses the pack with the product into the depression before the label is applied to the pack. The labeling result can be improved by pressing the pack into the depression.

The transport device can comprise a conveyor belt, where the boundary surfaces are arranged on the conveyor belt and the depressions are defined by the boundary surfaces and the conveyor belt at least in part, where the boundary surfaces are optionally connected in a detachable manner to the conveyor belt. With this embodiment, flexible adaptation to different pack formats is possible.

An extension of the depression in a direction transverse to the direction of transport can be greater than an extension of the depression parallel to the direction of transport. With this embodiment, elongate packs in particular can be reliably labeled even at a high throughput.

All embodiments presently described can be combined with one another.

### BRIEF DESCRIPTION OF THE DRAWINGS

FIG. 1 shows an embodiment of a labeling device for labeling packs filled with a product.

FIG. 2 shows schematically an embodiment of a conveyor belt.

### DETAILED DESCRIPTION

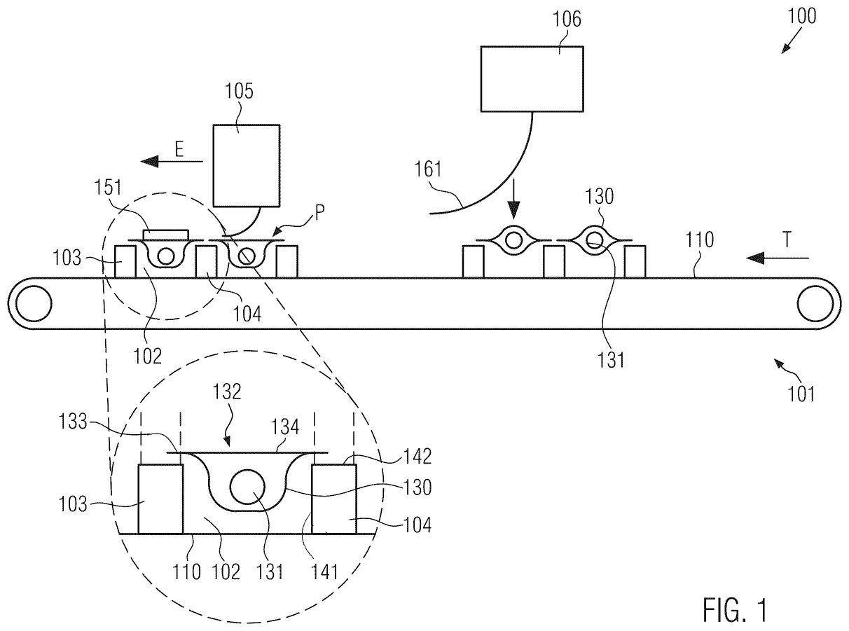

FIG. 1 shows a labeling device 100 for labeling packs 130 filled with a product 131 in a side view. In the embodiment presently shown, the packs are, for example, packs that are deep-drawn in part and comprise a receiving region for product 131 which in some embodiments can be formed as a flexible region, for example, in the form of a bag interior. In addition, the packs comprise a pack component 133 in which no product is arranged and which serves, for example, as a boundary of interior 132 and can comprise, for example, a sealing seam.

In the embodiment presently shown, packs 130 are elongate packs which can have a greater extension in particular in one direction than in a spatial direction perpendicular thereto, preferably in all spatial directions perpendicular thereto. For example, the packs can be packs for elongate sausages or cheese sticks or crackers.

Labeling device 100 comprises a transport device 101 which can transport packs 130 with product 131 filled thereinto along a direction of transport T. For this purpose, transport device 101 can comprise, for example, a conveyor belt 110 or a conveyor chain or the like on which products 130 can be conveyed along direction of transport T. The conveyor belt or the conveyor chain or the like can be configured, for example, as an endless conveyor belt.

Furthermore, the labeling device comprises a labeling unit 105 which can apply labels 151 onto packs 130 transported in transport device 101. It can be preferred that a labeling direction E in which labeling unit 105 applies labels 151 onto the packs is the same as direction of transport T of the packs in the transport device. This avoids shear forces acting upon the label during the application of the label, which, in contrast, could occur when the label is applied in a direction transverse to direction of transport T if the packs are transported onward while the label is being applied.

Labeling unit 105 can be configured in a basically known manner and can be arranged in particular above the transport devices in such a way that labels 151 can be applied onto the packs transported in transport device 101. Labels 151 can be kept, for example, on a label roll and can be present on this label roll, for example, as pre-cut labels on a label tape carrier from which they are separated by way of a dispensing edge before being transferred onto packs 130. Alternatively, embodiments are also conceivable in which the labels are already pre-cut and self-adhesive in a magazine and only have to be applied or pressed onto the packs. Other embodiments are presently also conceivable and the disclosure is not restricted with regard to the exact configuration of the labeling unit.

Transport device 101 further comprises, for example, as part of conveyor belt 110 depressions 102 and boundary surfaces 103 and 104 defining these depressions, where a first boundary surface 103 in the embodiment presently shown is arranged downstream of depression 102 and a second boundary surface 104 is arranged upstream of depression 102. In this embodiment, depression 102 is defined by a front boundary surface 103 and a rear boundary surface 104 as seen in the direction of transport. Further embodiments are also conceivable in which depression 102 is, for example, additionally or exclusively defined by boundary surfaces on the left- and right-hand sides as seen in the direction of transport.

Depression 102 and boundary surfaces 103 and 104 are configured in accordance with the enlarged view shown such that a first part 132 of the pack with product 131 can come to abut against depression 102 and a further pack component, such as the sealing seam or similar, presently referred to as pack component 133, can come to abut against boundary surfaces 103 and/or 104.

This results in a labeling surface 134 of pack 130 which is flat or flatter at least in part as compared to the original shape of the pack onto which a label 151 can be applied as wrinkle-free and reliably as possible. This is particularly advantageous for embodiments in which pack 130 has a greater extension extending transversely to direction of transport T than the extension of the pack in direction of transport T. In this way, the number of packs positioned per unit length of transport device 101 can be increased, since they do not have to be arranged successively in the longitudinal direction and yet a surface 134 that is sufficiently straight for labeling with a label 151 can be provided.

Boundary surfaces 103 and 104 can each comprise a side surface 141 pointing in the direction of depression 102 and a cover surface 142 on which pack component 132 can rest. Side surfaces 141 can extend vertically, for example, upwards from conveyor belt 110 and thus define depression 102 by vertical side surfaces. However, it can also be provided that side surfaces 141 form an angle with the surface of transport device 101 and in particular an angle with the surface of conveyor belt 110. This angle can be an angle measured between the surface of transport device 101 and side surface 141 and can be in particular an acute angle. This ensures that depression 102 tapers in the direction of transport device 101 or of the surface of conveyor belt 110 and can have a centering effect on the pack so that it can be reliably positioned in the depression.

Cover surfaces 142 can run horizontally or parallel to the surface of the transport device or conveyor belt 110, respectively, so that slanted positioning of the packs is avoided. A connecting edge between cover surface 142 and side surface 141 can be realized, if possible, with an obtuse angle or in a rounded manner so that there are no sharp edges that could damage pack 130.

An extension of boundary surfaces 103 and 104 parallel to the transport device can be selected in basically every embodiment described so that cover surface 142 or entire boundary surface 103 or 104 has an extension in direction of transport T that is so large that pack components 133 can come to a standstill thereon and not project beyond the respective cover surface 142 when first part 132 of the pack is positioned in depression 102.

Alternatively, it can also be provided that the extension of cover surface 142 corresponds to at least twice the extension of pack component 133 so that immediately successive depressions 102 can be separated from one another by a boundary surface, for example, boundary surface 104, and packs can be placed in depressions spaced as closely as possible to one another but without having parts of the packs overlap. This allows the throughput of the labeling process to be increased. In addition, this selection of the extension of boundary surface 104 ensures that there is no overlap or only the smallest possible overlap between immediately successive packs so that the labeling result is not impaired.

Furthermore, it can be ensured by appropriately selecting the extension of boundary surfaces 103 and 104 in direction of transport T that individual packs 130 as well as packs connected to one another can be labeled, where the extension of boundary surfaces 103 and 104 and in particular cover surface 142 is selected in this case such that it is preferably possible to introduce separated packs and packs connected to one another by way of respective pack components 133. This reduces any changeover effort when labeling individual packs and chain packs.

A pressing device 106 can be arranged upstream of labeling unit 105 and in particular upstream of a labeling point or application point P of labels onto the packs and is basically configured such that it can press packs, that have already been introduced at least in part into depression 102, in the direction of the depression so that the pack with the product or first part 132 of the pack with product 131 is pressed as completely as possible into depression 102. This ensures that the surface to be labeled is as flat as possible.

The pressing device can comprise a movable pressing element 161 which can be configured, for example, as a punch and presses each pack and/or a successive group of packs (packs connected to one another or not connected to one another) into the depression.

It can also be provided there that the activation of such a punch is effected based on a previous recognition that pressing a specific pack into the depression is required. For this purpose, suitable sensors, such as a camera, can be provided, where it can be determined based on the sensor data measured whether it is necessary for a specific pack to be pressed into the depression using the pressing device, and the pressing device is actuated only then for pressing the pack into the depression. In this way, packs can be selectively pressed into the depressions.

Instead of a punch, a movable pressing element can also be provided comprising or configured as a pressure roller 161. The pressure roller can be mounted to be rotatable about an axis of rotation running transverse to the direction of transport and be arranged above the transport plane so that packs transported underneath the pressure roller are pressed by the pressure roller in the direction of the depression. For this purpose, it can be provided that the pressure roller can be moved in analogy to the punch described.

Alternatively or additionally, it can also be provided that the pressure roller is pretensioned, for example, by a spring element, in the direction of the transport plane or the depression, respectively, and in the initial state of the pressure roller is at a distance from the transport plane that is smaller than the depth of a depression so that the pressure roller (in the absence of a pack) would project into the depression. If a pack is transported underneath the pressure roller in a depression, the pressure roller is raised against the spring force and can thereby cause the pack to be pressed into the depression.

The pressure roller can run along on the pack (i.e., be set in rotation about its axis of rotation by touching contact with the pack). Alternatively or additionally, a drive element (for example a servo motor) can also be provided for driving the pressure roller about the axis of rotation and can drive the pressure roller in such a way that the tangential speed on the surface of the pressure roller that comes into contact with the packs is equal to the transport speed of the packs in transport device 101. This reduces forces acting upon the packs in the direction opposite to the direction of transport, which enables more reliable transport.

Alternatively, it can also be provided that pressing element 161 is configured as a flexible or rigid pressing element. A flexible pressing element can be, for example, a metal spring or a rubber lip 161 which is positioned such that it either ends directly above boundary surfaces 103 and 104 or in a relaxed position can extend into a depression 102. The flexible pressing element 161 preferably runs transverse to direction of transport T and extends over the entire width of the transport device or at least over the entire pack width so that the entire pack is pressed into the depression and defects are avoided to the extent possible.

If a pack that is positioned in a depression at least in part is now moved in direction of transport T, flexible element 161 causes the pack to be pressed into depression 102, where the energy expenditure for this is comparatively low.

If the pressing element 161 is configured as a rigid pressing element 161, then it can be configured, for example, as a pressing element 161. It then preferably extends at least at a short distance from boundary surfaces 103 and 104 in order to avoid damaging the packs and in particular the packs components 133 when first pack part 132 is pressed into the depression. In one embodiment, this pressing element can be arranged in a fixed position above the transport device 101, extending towards the boundary surfaces 103 and 104 but having a smallest distance to the boundary surfaces 103 of at least 0.5 mm or at least 0.1 mm or at least 1 mm or at least 2 mm so as to press packs moved along the pressing element into the depression but to not contact the boundary surfaces 103 and 104.

Regardless of whether it is a flexible or rigid pressing element, pressing element 161 can preferably be inclined in direction of transport T so that the packs are not conveyed against the edge of pressing element 161, but rather strike against pressing element 161 in a flat manner and the edge or the end of pressing element 161 is only subsequently passed.

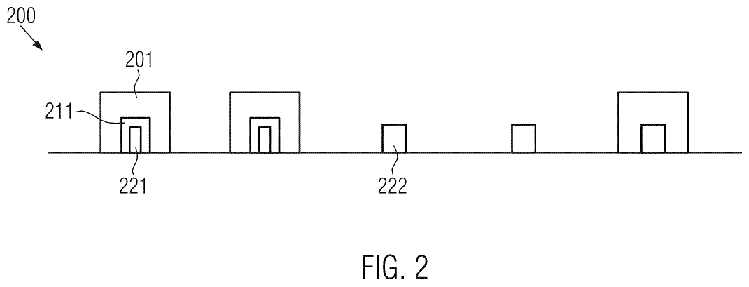

FIG. 2 shows a further embodiment of a transport device 200. In the embodiment shown there, the transport device comprises a conveyor belt 200 or is configured as a conveyor belt 200, respectively, and boundary surfaces 201 can be arranged on conveyor belt 200. It is provided there that boundary surfaces 201 can preferably be detachably connected to conveyor belt 200. For this purpose, each boundary surface 201 can comprise a receiving element 211 which can receive a connecting element 221 of conveyor belt 200 so that the boundary surface is connected firmly but in a detachable manner to conveyor belt 200.

Receiving element 211 can be, for example, a cavity, and connecting element 221 can be configured as a pin or peg or the like. Screw connections of boundary surface 201 to the conveyor belt are also conceivable, where receiving element 211 can then be configured as a hole running e.g., vertically or substantially vertically through boundary surface 201, and the screw can be screwed into this hole.

It is possible with this embodiment to vary the number of boundary surfaces and also their spacing such that, for example, regions with connecting elements 222 in a specific configuration of transport device 200 are not provided with a boundary surface 201. This makes it possible to adapt the transport device, for example, to intended groupings of packs.

In one embodiment, receiving elements 211 can also be provided in the conveyor belt and connecting elements 221 as part of the respective boundary surface. Regardless of this selection, it can be provided that each boundary surface comprises at least two receiving elements or connecting elements in a direction transverse to the direction of transport and the transport device comprises elements corresponding thereto. The spacing between connecting element 221 or receiving elements 211 in the transport device can be selected in the direction of transport such that different types of packs can be transported and reliably labeled by appropriately moving boundary surfaces such that only an exchange or displacement of boundary surfaces is preferably required with a change of types.

What is claimed is:

1. A labeling device for labeling packs filled with a product, the labeling device comprising a transport device for transporting packs along a direction of transport and a labeling unit for applying labels onto the packs, the transport device comprising a depression, for receiving a pack with a product, and boundary surfaces on at least two sides of the depression, wherein the depression and the boundary surfaces are arranged such that the pack with the product can be arranged in the depression and a pack component of the pack on at least one of the boundary surfaces, and wherein the labeling unit is configured to apply a label onto the pack while the product is arranged in the depression.

2. The labeling device according to claim 1, wherein the boundary surfaces are arranged to be transverse to the direction of transport.

3. The labeling device according to claim 2, wherein the labeling unit is configured to apply the label to the pack in a labeling direction parallel to the direction of transport.

4. The labeling device according to claim 2, wherein the transport device comprises a plurality of depressions and boundary surfaces.

5. The labeling device according to claim 4, wherein adjacent depressions are separated from one another by one of the boundary surfaces.

6. The labeling device according to claim 1, wherein the labeling device comprises a pressing device upstream of an application point for labels, and wherein the pressing device is configured to press the pack with the product into the depression.

7. The labeling device according to claim 1, wherein the transport device comprises a conveyor belt, and wherein the boundary surfaces are arranged on the conveyor belt and the depression is defined at least in part by the boundary surfaces and the conveyor belt.

8. The labeling device according to claim 7, wherein the boundary surfaces are connected in a detachable manner to the conveyor belt.

9. The labeling device according to claim 1, wherein an extension of the depression in a direction transverse to the direction of transport is greater than an extension of the depression parallel to the direction of transport.

10. A method for labeling packs filled with a product using a labeling device, the labeling device comprising a transport device for transporting packs along a direction of transport and a labeling unit for applying labels onto the packs, the transport device comprising a depression, for receiving a pack with a product, and boundary surfaces on at least two sides of the depression, wherein the depression and the boundary surfaces are arranged such that the pack with the product can be arranged in the depression and a pack component of the pack on at least one of the boundary surfaces, and wherein the method comprises applying a label onto the pack while the product is arranged in the depression.

11. The method according to claim 10, wherein the boundary surfaces are arranged to be transverse to the direction of transport.

12. The method according to claim 11, wherein the labeling unit applies the label to the pack in a labeling direction parallel to the direction of transport.

13. The method according to claim 10, wherein the transport device comprises a plurality of depressions and boundary surfaces.

14. The method according to claim 13, wherein adjacent depressions are separated from one another by one of the boundary surfaces.

15. The method according to claim 10, wherein the labeling device comprises a pressing device upstream of an application point for labels, and wherein the pressing device is configured to press the pack with the product into the depression before the label is applied to the pack.

16. The method according to claim 10, wherein the transport device comprises a conveyor belt, and wherein the boundary surfaces are arranged on the conveyor belt and the depression is defined by the boundary surfaces and the conveyor belt at least in part.

17. The method according to claim 16, wherein the boundary surfaces are connected in a detachable manner to the conveyor belt.

18. The method according to claim 10, wherein an extension of the depression in a direction transverse to the direction of transport is greater than an extension of depression parallel to direction of transport.
